(19) United States
(12) Patent Application Publication
(10) Pub. No.: US 2007/0015871 A1
(43) Pub. Date: Jan. 18, 2007

(54) Thermoplastic elastomer composition

(75) Inventors: Takeo Nakamura, Chuo-ku (JP); Teruo Aoyama, Chuo-ku (JP); Akihiko Morikawa, Chuo-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: JSR Corporation, Chuo-ku (JP)

(21) Appl. No.: 11/483,598

(22) Filed: Jul. 11, 2006

(30) Foreign Application Priority Data
Jul. 12, 2005 (JP) 2005-202557

(51) Int. Cl. C08L 53/00

(52) U.S. Cl. 525/88

(57) ABSTRACT

A thermoplastic elastomer composition comprising: (A) 85-98 wt % of syndiotactic 1,2-polybutadiene having a 1,2-bond content of 70% or more and a degree of crystallinity of 5-50% and (B) 2-15 wt % of a styrene-butadiene-styrene block copolymer and/or styrene-isoprene-styrene block copolymer is disclosed. Since the thermoplastic elastomer composition and a molded article made from the composition can be firmly bonded with a polar resin using an organic solvent, the composition is useful as a material of components used for medical treatment such as an infusion set for medical treatment.

### BACKGROUND OF THE INVENTION

1. Field of the Invention

The present invention relates to a thermoplastic elastomer composition exhibiting excellent adhesion with a polar resin, a method for bonding the molded article of the thermoplastic elastomer composition with a polar resin molded article, a composite molded article produced by bonding the molded article of the thermoplastic elastomer composition with the polar resin molded article, and an infusion set for medical treatment equipped with the composite molded article.

2. Background Art

Components produced by bonding a molded article of vinyl chloride resin (PVC) with a molded article of a polar resin are used for various applications. For example, an infusion set for medical treatment produced by solvent bonding of a PVC tube with a connector made of a polar resin is commercially available. However, PVC has problems of leakage of plasticizers and chlorine generation during burning. In addition, the infusion set for medical treatment has a problem of medical fluid adsorption in PVC due to high polarity of PVC. A material that can be used in place of PVC has been demanded.

As an alternative material to PVC, polybutadiene represented by syndiotactic 1,2-polybutadiene is attracting attention. The inventors of the present invention have proposed components for use in medical treatment in which a tube made of syndiotactic 1,2-polybutadiene is bonded to a connector made of syndiotactic 1,2-polybutadiene (Japanese Patent Application Laid-open No. 2004-321788). However, when a polar resin is used as a partner of bonding, the syndiotactic 1,2-polybutadiene may exhibit only a low bonding force because of its low polarity. An increase in the bonding force of syndiotactic 1,2-polybutadiene with a polar resin has been desired.

The present invention has been achieved in view of the above problems. An object of the present invention is to provide a thermoplastic elastomer composition which can be firmly bonded to a polar resin using an organic solvent, a method of bonding using the thermoplastic elastomer composition, a composite molded article, and an infusion set for medical treatment.

### SUMMARY OF THE INVENTION

As a result of extensive studies to improve adhesiveness of syndiotactic 1,2-polybutadiene with a polar resin with an object of solving the aforementioned problems, the present inventors have found that the adhesiveness with a polar resin can be improved without impairing characteristics of the syndiotactic 1,2-polybutadiene by adding a small amount of a styrene-diene-styrene block copolymer with a styrene content of a specific range to syndiotactic 1,2-polybutadiene. The present invention has been completed based on this finding and provides the following thermoplastic elastomer composition, method of bonding molded articles, composite molded articles, and infusion set for medical treatment.

(1) A thermoplastic elastomer composition comprising:

(A) 85-98 wt % of syndiotactic 1,2-polybutadiene having a 1,2-bond content of 70% or more and a degree of crystallinity of 5-50% and

(B) 2-15 wt % of a styrene-butadiene-styrene block copolymer and/or styrene-isoprene-styrene block copolymer with a styrene content of 35-45 wt %, provided that (A)+(B) is 100 wt %.

(2) The thermoplastic elastomer composition according to (1), wherein the thermoplastic elastomer composition is a composition for medical use.

(3) A method for bonding molded articles, comprising bonding a molded article of the thermoplastic elastomer composition according to (1) or (2) with (C) a polar resin molded article using (D) an organic solvent.

(4) The method for bonding molded articles according to (3), wherein the polar resin (C) is at least one resin selected from the group consisting of a polycarbonate resin, ABS resin, polyurethane resin, polyamide resin, poly(ethylene terephthalate) resin, poly(alkyl acrylate) resin, poly(alkyl methacrylate) resin, polyacetal resin, poly(vinyl chloride) resin, and poly(vinylidene chloride) resin.

(5) The method for bonding molded articles according to (3) or (4), wherein the organic solvent (D) is at least one solvent selected from the group consisting of cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid.

(6) A composite molded article comprising a molded article of the thermoplastic elastomer composition according to (1) or (2) bonded with a molded article of a polar resin (C).

(7) The composite molded article according to (6), wherein the polar resin (C) is at least one resin selected from the group consisting of a polycarbonate resin, ABS resin, polyurethane resin, polyamide resin, poly(ethylene terephthalate) resin, poly(alkyl acrylate) resin, poly(alkyl methacrylate) resin, polyacetal resin, poly(vinyl chloride) resin, and poly(vinylidene chloride) resin.

(8) The composite molded article according to (6) or (7), wherein the molded articles are bonded using a solvent adhesive in which at least one organic solvent selected from the group consisting of cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid is used.

(9) An infusion set for medical treatment equipped with the composite molded article according to any one of (6) to (8).

The thermoplastic elastomer composition of the present invention exhibits excellent adhesion with polar resins due to the composition in which small amounts of a styrene-butadiene-styrene block copolymer (hereinafter referred to from time to time as “SBS”) and/or a styrene-isoprene-styrene block copolymer (hereinafter referred to from time to time as “SIS”) with a styrene content of a specific range are added to a syndiotactic 1,2-polybutadiene. In addition, a composite molded article with high bonding strength can be obtained by the method of bonding a polar resin using the thermoplastic elastomer composition.

### BRIEF DESCRIPTION OF THE DRAWINGS

FIG. 1(a) is a schematic diagram of a connector and FIG. 1(b) is a schematic diagram of a tube.

FIG. 2 is a schematic plan view showing one embodiment of the infusion set equipped with a molded article made from the thermoplastic elastomer composition of the present invention.

### DETAILED DESCRIPTION OF THE INVENTION AND PREFERRED EMBODIMENTS

The thermoplastic elastomer composition, a method of bonding and a composite molded article using this composition, and an infusion set for medical treatment of the present invention will be described in detail by means of specific embodiments. The following description, however, should not be construed as limiting the present invention.

<Thermoplastic Elastomer Composition>

The thermoplastic elastomer composition of the present invention comprises (A) syndiotactic 1,2-polybutadiene and (B) a styrene-butadiene-styrene block copolymer (SBS) and/or a styrene-isoprene-styrene block copolymer (SIS). Each of them is described in detail below.

(A) Syndiotactic 1,2-polybutadiene

The syndiotactic 1,2-polybutadiene used in the present invention has a 1,2-bond content of 70% or more and a degree of crystallinity of 5-50% (hereinafter referred to from time to time as “component (A)”). A 1,2-bond content of 70% or more, preferably 80% or more, and still more preferably 90% or more ensures the composition to exhibit excellent characteristics as a thermoplastic elastomer. In addition, a degree of crystallinity of 5-50%, and preferably 10-40% ensures the syndiotactic 1,2-polybutadiene to possess excellently balanced dynamics strength, such as tensile strength and tear strength, and flexibility. The melting point (Tm) is preferably 50-150° C., and more preferably 60-140° C. The melting point in this range ensures that the syndiotactic 1,2-polybutadiene possesses excellently balanced heat resistance, dynamics strength, and flexibility. The 1,2-bond content is a value determined by infrared absorption spectrometry (Morelo method). The degree of crystallinity is a value converted from the density measured by the underwater replacement method assuming the density of 1,2-polybutadiene with a degree of crystallinity of 0% to be 0.889 g/cm³ and the density of 1,2-polybutadiene with a degree of crystallinity of 100% to be 0.963 g/cm³.

Syndiotactic 1,2-polybutadiene with a degree of crystallinity of about 5-25% (hereinafter referred to from time to time as “low crystalline syndiotactic 1,2-polybutadiene”) is suitably used as a tube for an infusion set for medical treatment due to the excellent flexibility. The low crystalline syndiotactic 1,2-polybutadiene, however, exhibits poor steam sterilization resistance due to the low melting point of about 70-95° C. It is possible to provide such a syndiotactic 1,2-polybutadiene with heat resistance by cross-linking the polymer by electron beam irradiation described later. On the other hand, syndiotactic 1,2-polybutadiene with a degree of crystallinity of about 25-50% (hereinafter referred to from time to time as “high crystalline syndiotactic 1,2-polybutadiene”) is suitably used as a joint to connect a connector and tubes of an infusion kit for medical treatment due to the comparatively high melting point of about 105-140° C. and comparatively high rigidity.

The syndiotactic 1,2-polybutadiene used in the present invention may contain a small amount of conjugated dienes other than butadiene copolymerized with butadiene. As the conjugated dienes other than butadiene, 1,3-pentadiene, 1,3-butadiene derivatives substituted with a higher alkyl group, 2-alkyl-substituted 1,3-butadiene, and the like can be given. As examples of the 1,3-butadiene derivative substituted with a higher alkyl group, 1-pentyl-1,3-butadiene, 1-hexyl-1,3-butadiene, 1-heptyl-1,3-butadiene, 1-octyl-1,3-butadiene, and the like can be given.

As examples of typical 2-alkyl-substituted 1,3-butadienes, 2-methyl-1,3-butadiene (isoprene), 2-ethyl-1,3-butadiene, 2-propyl-1,3-butadiene, 2-isopropyl-1,3-butadiene, 2-butyl-1,3-butadiene, 2-isobutyl-1,3-butadiene, 2-amyl-1,3-butadiene, 2-isoamyl-1,3-butadiene, 2-hexyl-1,3-butadiene, 2-cyclohexyl-1,3-butadiene, 2-isohexyl-1,3-butadiene, 2-heptyl-1,3-butadiene, 2-isoheptyl-1,3-butadiene, 2-octyl-1,3-butadiene, 2-isooctyl-1,3-butadiene, and the like can be given. Among these conjugated dienes, isoprene and 1,3-pentadiene can be given as preferable conjugated dienes to be copolymerized with butadiene. The butadiene content of monomer components to be polymerized is preferably 50 mol % or more, and particularly preferably 70 mol % or more.

The syndiotactic 1,2-polybutadiene used in the present invention can be obtained by polymerizing butadiene in the presence of a catalyst containing a cobalt compound and aluminoxane, for example. As the cobalt compound, an organic acid salt of an organic acid preferably with four or more carbon atoms and cobalt can be given. As specific examples of the organic acid salt, butyrate, hexanoate, heptylate, octylate such as 2-ethylhexylate, decanoate, salts of higher fatty acid such as stearic acid, oleic acid, and erucic acid, benzoate, tolylate, xylylate, alkyl-substituted, aralkyl-substituted, or allyl-substituted benzoates such as ethyl benzoate, naphthoate, and alkyl-substituted, aralkyl-substituted, or allyl-substituted naphthoates can be given. Of these, octylates such as 2-ethylhexylate, stearate, and benzoate are preferable due to excellent solubility in hydrocarbon solvents.

As the above-mentioned aluminoxane, aluminoxanes represented by the following formulas (I) and (II), for example, can be mentioned.

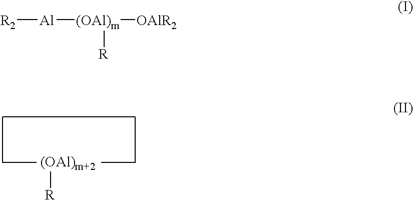

In aluminoxanes represented by the formulas (I) and (II), R is a hydrocarbon group such as a methyl group, an ethyl group, a propyl group, or a butyl group, preferably a methyl group or an ethyl group, and particularly preferably a methyl group. m is an integer of 2 or more, preferably 5 or more, and still more preferably 10-100. As the specific examples of aluminoxane, methylaluminoxane, ethylaluminoxane, propylaluminoxane, butylaluminoxane, and the like can be given. Of these, methylaluminoxane is particularly preferable.

It is extremely preferable for the polymerization catalyst to contain a phosphine compound in addition to the cobalt compound and aluminoxane. The phosphine compound is effective for activating the polymerization catalyst and controlling the vinyl bond structure and crystallinity. As a preferable phosphine compound, an organic phosphorus compound shown by the following formula (III) can be given.
P—(Ar)ₙ—(R′)₃₋ₙ (III)
wherein R′ represents a cycloalkyl group or an alkyl-substituted cycloalkyl group, n is an integer of 0-3, and Ar represents a group shown by the following formula, 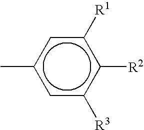
wherein R¹, R², and R³ which may be either the same or different, represent a hydrogen atom, an alkyl group, a halogen atom, an alkoxy group, or an aryl group.

As examples of the alkyl group, alkoxy group, and aryl group represented by R¹, R², or R³, alkyl groups having 1-6 carbon atoms, alkoxy groups having 1-6 carbon atoms, and aryl groups having 6-12 carbon atoms are preferable.

As specific examples of the phosphine compound represented by the formula (III), tris(3-methylphenyl)phosphine, tris(3-ethylphenyl)phosphine, tris(3,5-dimethylphenyl)phosphine, tris(3,4-dimethylphenyl)phosphine, tris(3-isopropylphenyl)phosphine, tris(3-t-butylphenyl)phosphine, tris(3,5-diethylphenyl)phosphine, tris(3-methyl-5-ethylphenyl)phosphine, tris(3-phenylphenyl)phosphine, tris(3,4,5-trimethyl phenyl)phosphine, tris(4-methoxy-3,5-dimethylphenyl)phosphine, tris(4-ethoxy-3,5-diethylphenyl)phosphine, tris(4-butoxy-3,5-dibutylphenyl)phosphine, tris(p-methoxyphenyl)phosphine, tricyclohexylphosphine, dicyclohexylphenylphosphine, tribenzylphosphine, tris(4-methylphenyl)phosphine, and tris(4-ethylphenyl)phosphine can be given. Of these, triphenylphosphine, tris(3-methylphenyl)phosphine, tris(4-methoxy-3,5-dimethylphenyl)phosphine, and the like are particularly preferable.

As the cobalt compound, a compound of the following formula (IV) can be used.

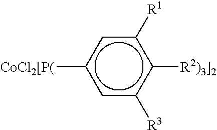

The compound of the formula (IV) is a complex of cobalt chloride with a phosphine compound having n=3 in the above formula (III) as a ligand. In the polymerization, either a method of using a previously synthesized cobalt compound of the formula (IV) or a method of causing cobalt chloride to come in contact with the phosphine compound in the polymerization system may be employed. The 1,2-bond content and the degree of crystallinity of the syndiotactic 1,2-polybutadiene can be controlled by appropriately selecting the type of phosphine compound in the complex.

As specific examples of the cobalt compound represented by the formula (IV), cobalt bis(triphenylphosphine) dichloride, cobalt bis[tris(3-methylphenyl)phosphine] dichloride, cobalt bis[tris(3-ethylphenyl)phosphine] dichloride, cobalt bis[tris(4-methylphenyl)phosphine] dichloride, cobalt bis[tris(3,5-dimethylphenyl)phosphine] dichloride, cobalt bis[tris(3,4-dimethylphenyl)phosphine] dichloride, cobalt bis[tris(3-isopropylphenyl)phosphine] dichloride, cobalt bis[tris(3-t-butylphenyl)phosphine] dichloride, cobalt bis[tris(3,5-diethylphenyl)phosphine] dichloride, cobalt bis[tris(3-methyl-5-ethylphenyl)phosphine] dichloride, cobalt bis[tris(3-phenylphenyl)phosphine] dichloride, cobalt bis[tris(3,4,5-trimethylphenyl)phosphine] dichloride, cobalt bis[tris(4-methoxyl-3,5-dimethylphenyl)phosphine] dichloride, cobalt bis[tris(4-ethoxyl-3,5-diethylphenyl)phosphine] dichloride, cobalt bis[tris(4-butoxy-3,5-dibutylphenyl)phosphine] dichloride, cobalt bis[tris(4-methoxyphenyl)phosphine] dichloride, cobalt bis[tris(3-methoxyphenyl)phosphine] dichloride, cobalt bis[tris(4-dodecylphenyl)phosphine] dichloride, and cobalt bis[tris(4-ethylphenyl)phosphine] dichloride can be used.

Of these, cobalt bis(triphenylphosphine) dichloride, cobalt bis[tris(3-methylphenyl)phosphine] dichloride, cobalt bis[tris(3,5-dimethylphenyl)phosphine] dichloride, cobalt bis[tris(4-methoxy-3,5-dimethylphenyl)phosphine] dichloride, and the like are particularly preferable.

The amount of the cobalt compound in the catalyst used in the polymerization of butadiene or copolymerization of butadiene and other conjugated dienes, in terms of the amount of cobalt per one mol of butadiene (in the case of homopolymerization) or the total of butadiene and the other conjugated dienes (in the case of copolymerization), is 0.001-1 mmol, and preferably 0.01-0.5 mmol. The amount of the phosphine compound, in terms of the ratio of phosphorus atom to cobalt atom (P/Co), is usually 0.1-50, preferably 0.5-20, and more preferably 1-20. The amount of aluminoxane, in terms of the ratio of aluminum atom to cobalt atom (Al/Co), is usually 4-10⁷, and preferably 10-10⁶. When the complex compound of the formula (IV) is used, the amount of the phosphine compound, in terms of the ratio of phosphorus atom to cobalt atom (P/Co), is 2, and the aluminoxane is used in an amount described above.

As the inert organic solvent used as a polymerization solvent, aromatic hydrocarbon solvents such as benzene, toluene, xylene, and cumene; aliphatic hydrocarbon solvents such as n-pentane, n-hexane, and n-butane; alicyclic hydrocarbon solvents such as cyclopentane, methylcyclopentane, and cyclohexane; and mixtures of these solvents can be given.

The polymerization temperature is usually −50 to 120° C., and preferably −20 to 100° C. Either a batch polymerization system or a continuous polymerization system may be used for the polymerization reaction. The monomer concentration in the solvent is usually 5-50 wt %, and preferably 10-35 wt %. In order to produce polymers without deactivating the catalyst and polymer of the present invention, strict care must be taken to minimize inclusion of compounds that deactivate the catalyst and polymer, such as oxygen, water, or carbon dioxide gas, in the polymerization system. When the polymerization reaction has proceeded to a desired stage, alcohol and other additives such as a polymerization terminator, aging preventive, antioxidant, UV absorber, and the like are added, and the produced polymer is separated, washed, and dried according to a conventional method to obtain syndiotactic 1,2-polybutadiene.

The weight average molecular weight of (A) the syndiotactic 1,2-polybutadiene used in the present invention is preferably 10,000-5,000,000, more preferably 10,000-1,500,000, and particularly preferably 50,000-1,000,000. If the weight average molecular weight is less than 10,000, the polymer exhibits extremely high fluidity, is very difficult to process, and produces sticky molded products. If the weight average molecular weight is more than 5,000,000, on the other hand, the polymer exhibits extremely low fluidity and is very difficult to be processed.

### (B) Styrene-butadiene-styrene block copolymer (SBS) and/or styrene-isoprene-styrene block copolymer (SIS)

The SBS and/or SIS used in the present invention are tri-block copolymers having a styrene content of 35-45 wt % (hereinafter referred to from time to time as “component (B)”).

Excellent adhesiveness with polar resins can be exhibited by adding SBS and/or SIS having a styrene content of 35-45 wt % to the component (A), which is syndiotactic 1,2-polybutadiene. Adhesiveness with polar resins does not sufficiently increase either in the case in which the styrene content of SBS or SIS is too great or too small. Only SBS and/or SIS with a limited styrene content can exhibit an improved effect.

SBS and SIS can be polymerized by a conventionally known method. For example, a process of polymerizing styrene in the presence of ether or a tertiary amine using an organolithium compound as an initiator in a hydrocarbon solvent and further copolymerizing styrene and butadiene or isoprene, followed by still further polymerizing styrene, can be employed. Alternatively, a process of polymerizing styrene in the presence of ether or a tertiary amine using an organolithium compound as an initiator in a hydrocarbon solvent and further copolymerizing styrene and butadiene or isoprene, followed by a coupling reaction using a known coupling agent such as tetrachlorosilane, a silicon halide, and the like, can be employed. Commercially available SBS and/or SIS can also be used. Examples of the commercially available products include “TR2000” and “TR2003” manufactured by JSR Corp., “Toughprene 125” and “Toughprene 126” manufactured by Asahi Kasei Chemicals Corp., and the like.

Although there are no specific limitations to the molecular weight of molecules of SBS and SIS, the weight average molecular weight is preferably 10,000-5,000,000, more preferably 10,000-1,500,000, and particularly preferably 50,000-1,000,000. A weight average molecular weight less than 10,000 is not preferable due to low mechanical strength. A weight average molecular weight of more than 5,000,000 is undesirable because of low fluidity and poor processability.

The component (A) and the component (B) are added in an amount respectively of 85-98 wt % and 2-15 wt %, and preferably 90-97 wt % and 3-10 wt %, of the total amount of the component (A) and component (B). If the amount of the component (B) is less than 2 wt %, the effect of adhesiveness improvement with polar resins due to the addition of the component (B) is insufficient; if more than 15 wt %, characteristics of syndiotactic 1,2-polybutadiene may be impaired by, for example, an unduly increase in the haze value of molded articles. In particular, since transparency to the extent that the content is visible is required for the thermoplastic elastomer composition of the present invention when it is used for an infusion set for medical treatment, the haze value of a molded article with a thickness of 1 mm is preferably 80% or less.

As required, in addition to the components (A) and (B), the composition of the present invention may contain additives such as a lubricant, filler, foaming agent, and the like. Given as specific examples of the additives are lubricants such as paraffin oil, silicone oil, liquid polyisoprene, liquid polybutadiene, erucic acid amide, stearic acid amide; fillers such as talc, silica, magnesium hydroxide, calcium carbonate, glass, carbon fiber, and glass balloon; and foaming agents such as “Microsphere” manufactured by Matsumoto Yushi-Seiyaku Co., Ltd., ADCA, OBSH, and sodium bicarbonate. The lubricant is added in an amount of 5 parts by weight or less, and preferably 0.01-3 parts by weight for 100 parts by weight of the total amount of the components (A) and (B). An amount of more than 5 parts by weight is undesirable because the lubricant may bleed out.

In addition, in order to increase balance between heat resistance by irradiation with electron beams and flexibility, other additives, for example, a polyfunctional monomer such as trimethylpropane trimethacrylate, a photoinitiator such as hydroxycyclohexyl phenyl ketone, and a photosensitizer such as benzophenone, in an amount of 5 parts by weight or less for 100 parts by weight of the component (A) may be added. The total amount of organic additives other than the components (A) and (B) in the composition of the present invention is preferably 20 parts by weight or less, and more preferably 10 parts by weight or less for 100 parts by weight of the total amount of the components (A) and (B).

<Preparation and Molding of Composition>

The thermoplastic elastomer composition of the present invention can be obtained by adding the components (A) and (B) and the above optional additives and the like and kneading the mixture with heating. The resulting composition can be molded to prepare molded articles. Kneading and molding are carried out at a temperature equal to or higher than the softening point or melting point of the composition, at which the thermoplastic elastomer composition can be excellently molded to obtain a uniform molded article. For this reason, the kneading temperature and molding temperature are preferably 90-170° C. In order to obtain molded articles such as a tube and joint, molding methods such as press molding, extrusion molding, injection molding, blow molding, variant extrusion molding, T-die film molding, inflation molding, powder slash molding, rotational molding, and the like are used.

<Electron Beam Irradiation>

Since flexibility is required for producing a tube for an infusion set for medical treatment from the thermoplastic elastomer composition of the present invention, the use of syndiotactic 1,2-polybutadiene having a low degree of crystallinity as component (A) is preferable. In this case, because the low crystalline syndiotactic 1,2-polybutadiene has a low melting point, the molded article can be irradiated with electron beams for cross-linking in order to provide steam sterilization resistance and the like. Irradiation with electron beams produces syndiotactic 1,2-polybutadiene with a three-dimensional crosslinking structure by radical polymerization of vinyl groups, resulting in improved heat resistance of the molded articles. Electron beams are penetrable through a resin and the degree of penetration depends on the thickness of molded articles and kinetic energy of electron beams. A molded article with a uniform degree of cross-linking in the thickness direction can be obtained by controlling the energy of electron beams so that the electron beams may uniformly penetrate in the thickness direction according to the irradiation thickness. For example, if the energy of electron beams is controlled so that the electron beams uniformly penetrate in the thickness direction of a tube to be molded, a tube with a uniform degree of cross-linking in the thickness direction of the tube can be obtained. A joint which connects the tube with a connector may also be irradiated with electron beams. Irradiation with electron beams may be carried out either before or after bonding the tube with the connector, or may be carried out either before or after bonding the connector with the joint.

Electron beam energy applied to molded articles of the thermoplastic elastomer composition such as a tube, in terms of electron beams accelerating voltage, is preferably 50-3,000 kV, and still more preferably 300-2,000 kV. If less than 50 kV, the relative amount of electrons captured and absorbed near the surface layer increases and the amount of electron beams penetrating the molded articles decreases, resulting in a retardation of cross-linking in the inner part as compared with the surface and in variations in the degree of cross-linking. If more than 3,000 kV, the degree of cross-linking is too great and the resulting molded articles exhibit considerable hardness and small elasticity and elongation.

The irradiation dose of electron beams is preferably 1-100 Mrad (corresponding to 10-1,000 kGy of the SI units), and more preferably 1-50 Mrad. If less than 1 Mrad, the degree of cross-linking of the syndiotactic 1,2-polybutadiene is too small. If more than 100 Mrad, the degree of cross-linking is too great, resulting in molded articles exhibiting a high degree of hardness and small elasticity and elongation.

The degree of cross-linking by electron beam irradiation can be indicated by the product of the electron beam accelerating voltage and the irradiation dose. The product of the electron beam accelerating voltage (kV) and the irradiation dose (Mrad) is preferably 2,000-20,000 (kV·Mrad), and more preferably 5,000-16,000 (kV·Mrad). If less than 2,000 (kV·Mrad), the amount of electrons captured and absorbed near the surface layer comparatively increases and the amount of electron beams penetrating the molded articles of the thermoplastic elastomer composition decreases, resulting in a retardation of cross-linking in the inner part as compared with the surface and in variations in the degree of cross-linking. If more than 20,000 kV·Mrad, the degree of cross-linking is too great and the resulting molded articles exhibit a high degree of hardness and small elasticity and elongation.

By irradiating a molded article made from the thermoplastic elastomer composition of the present invention with electron beams in this way, the ratio of the modulus of elasticity (M2₅₀) at 50% elongation of a part for medical use after the electron beam irradiation to the modulus of elasticity (M1₅₀) at 50% elongation before the electron beam irradiation can be controlled, preferably to 1.1-2.5, and more preferably to 1.1-2.0. If the ratio of M2₅₀/M1₅₀ is less than 1.1, crosslinking by electron beam irradiation is insufficient and the effect of improving heat resistant such as steam sterilization resistance and the like is inadequate. If the ratio is greater than 2.5, on the other hand, cross-linked thermoplastic elastomer molded article is too stiff and not flexible. The ratio of M2₅₀/M1₅₀ can be easily controlled by controlling the product of the electron beam accelerating voltage (kV) and the irradiation dose (Mrad) in the range of 2,000-20,000 (kV·Mrad).

Molded articles of the thermoplastic elastomer composition such as a tube cross-linked by electron beam irradiation in this manner have steam sterilization resistance. For example, products such as a tube and joint used for an infusion set for medical treatment which are cross-linked after molding are not deformed when sterilized with steam at 100-121° C. for about 10-20 minutes. Steam sterilization resistance, here, refers to properties of a molded article, such as a transfusion tube or joint (e.g. a tube with an inner diameter of 3 mm, an outer diameter of 4.4 mm, a thickness of 0.7 mm, and a length of 20 cm), of maintaining the original round shape without being deformed, when sterilized with steam at 121° C. for 20 minutes in a high pressure steam sterilizer.

The toluene insoluble matter content of the molded article of the thermoplastic elastomer composition after irradiation with electron beams is usually 50-99 wt %, and preferably 80-95 wt %. The toluene insoluble matter content is an indicator of the cross-linking degree of double bonds in (A) syndiotactic 1,2-polybutadiene by irradiation of the polybutadiene molded article with electron beams. In determining the toluene insoluble matter content, a molded article [(a) g] of the thermoplastic elastomer composition of the present invention is dipped in 100 ml of toluene, allowed to stand at 30° C. for 48 hours, and filtered through a 100 mesh wire gauze. A portion [(c) ml] of the filtrate is collected and dried to solidify by vaporization to obtain a residual solid [toluene soluble matter (b) g]. The toluene insoluble matter content is calculated using the following equation.
Toluene insoluble content (wt %)=[{a−b×(100/c)}/a]×100

If the toluene insoluble matter content is less than 50 wt %, cross-linking by electron beam irradiation is insufficient. Neither heat resistance nor steam sterilization resistance can be improved sufficiently. If more than 99 wt %, the degree of cross-linking is too great. The resulting molded article is too hard and is not elastic. The toluene insoluble matter can be easily controlled by controlling the product of the electron beam accelerating voltage (kV) and the irradiation dose (Mrad) in the range of 2,000-20,000 (kV·Mrad).

In addition, the halogen atom content of the thermoplastic elastomer composition of the present invention is preferably not more than 200 ppm, and more preferably not more than 100 ppm. The halogen atom content of 1,2-polybutadiene can be reduced preferably to 200 ppm or less, and more preferably to 100 ppm or less by using a non-halogen type inert organic solvent as a polymerization solvent as described above, for example. In addition, if only non-halogen type compounds are used in the catalyst system, the halogen atom content of the thermoplastic elastomer composition can be further reduced.

<Method of Bonding>

The method for bonding of the present invention comprises bonding the above-described molded article of the thermoplastic elastomer composition with (C) a molded article of a polar resin using (D) an organic solvent.

### (C) Polar Resin

The polar resin used in the bonding method of the present invention is broadly defined as a resin possessing electric polarity and ionicity. The specific examples of the polar resin include thermoplastic plastics such as ABS resin; polyurethane resin; acrylic resin; polyacrylamide resin; polyacrylic resin; poly(alkyl acrylate) resins such as poly(methyl acrylate) resin and poly(ethyl acrylate) resin; polyacrylonitrile resin; acrylonitrile-styrene copolymer resin; polymethacrylamide resin; polymethacrylic resin; poly(alkyl methacrylate) resins such as poly(methyl methacrylate) resin and poly(ethyl methacrylate) resin; polymethacrylonitrile resin; polyacetal resin; ionomer; poly(ethylene chloride) resin; coumarone indene resin; regenerated cellulose resin; petroleum resin; alkali cellulose, cellulose ester, and cellulose acetate; cellulose acetate butylate; cellulose xantate; cellulose derivative resins such as cellulose nitrate, cellulose ether, carboxymethylcellulose, and cellulose ether ester; fluororesins such as FEP, polychlorotrifluoroethylene, polytetrafluoroethylene, poly(vinylidene fluoride), and poly(vinyl fluoride); polyamide resins such as nylon 11, nylon 12, nylon 6, nylon 6,10, nylon 6,12, nylon 6,6, and nylon 4,6; aromatic polyamide resins such as poly(phenyleneisophthalamide), poly(phenyleneterephthalamide), and m-xylylenediamine; polyimide resin; poly(phenylene sulfide) resin; polyether ether ketone resin; polyamideimide resin; polyester resins such as polyallylate, poly(ethylene terephthalate), and poly(butylene terephthalate); poly(vinyl chloride) resin; poly(vinylidene chloride) resin; chlorosulfonated polyethylene resin; polycarbonate resin; CR-39; polysulfone resin; polyether sulfone resin; polysulfoneamide resin; poly(vinyl alcohol) resin; polyvinyl ester resins such as poly(vinyl cinnamate) and poly(vinyl acetate); polyvinyl ether resins such as poly(isobutyl vinyl ether) and poly(methyl vinyl ether); poly(phenylene oxide) resin; thermoset plastics such as amino resin; aniline resin; urea resin; polysulfoneamide resin; melamine resin; allyl resin; diallyl phthalate resin; alkyd resin; epoxy resin; silicone resin; vinyl ester resin; phenol resin; novolac resin; resorcinol resin; unsaturated polyester resin; low-shrinkage unsaturated polyester resin; and furan resin.

Of these, preferable polar resins are a polycarbonate resin; polyester resins such as poly(ethylene terephthalate) and poly(butylene terephthalate); ABS resin; polyurethane resin; polyamide resin; poly(alkyl (meth)acrylate) resin, polyacetal resin, poly(vinyl chloride) resin, and poly(vinylidene chloride) resin are preferable.

The solubility parameter (SP value) of the polar resin is preferably 9-16, and more preferably 9.5-14. The solubility parameter here is a value calculated using a “Small” group parameter of the group contribution method described in Polymer Handbook (fourth edition, section VII, pp 682-685 (1999) published by John Wiley & Son). For example, the solubility parameter of poly(methyl methacrylate) (recurring unit molecular weight: 100 g/mol, density=1.19 g/cm³) is 9.25 (cal/cm³)^{1/2}, the solubility parameter of poly(butyl acrylate) (recurring unit molecular weight: 128 g/mol, density=1.06 g/cm³) is 8.97 (cal/cm³)^{1/2}, the solubility parameter of poly(butyl methacrylate) (recurring unit molecular weight: 142 g/mol, density=1.06 g/cm³) is 9.47 (cal/cm³)^{1/2}, the solubility parameter of polystyrene (recurring unit molecular weight: 104 g/mol, density=1.05 g/cm³) is 9.03 (cal/cm³)^{1/2}, and the solubility parameter of polyacrylonitrile (recurring unit molecular weight: 53 g/mol, density=1.18 g/cm³) is 12.71 (cal/cm³)^{1/2}. In the above solubility parameter determination, the densities of polymers described in ULLMANN'S ENCYCLOPEDIA OF INDUSTRIAL CHEMISTRY (vol. A21, page 169 (1992) published by VCH) were used. In regard to the solubility parameter δc of copolymers, when the content of recurring units of minor monomers was less than 5 wt %, the solubility parameter of the main component polymer was used. When the content of recurring units of minor monomers was 5 wt % or more, the weighted average of the solubility parameter was used. Specifically, the solubility parameter δc of a copolymer made from m types of different monomers can be calculated from each of the solubility parameters δn of homopolymers of the component monomers forming the copolymer and the weight percentage (Wn) of the monomers using the following formula.

$$δ c = {\sum }_{n = 1}^{n = m} δ nWn / {\sum }_{n = 1}^{n = m} Wn$$

For example, the solubility parameter of the copolymer made from 75 wt % of styrene and 25 wt % of acrylonitrile can be calculated as 9.95 (cal/cm³)^{1/2} by assigning the solubility parameter of polystyrene of 9.03 (cal/cm³)^{1/2} and the solubility parameter of polyacrylonitrile of 12.71 (cal/cm³)^{1/2} to the above formula.

As the polar resin molded articles used in the present invention, connectors, infusion set auxiliary implements, and the like made from above-mentioned various polar resins can be given.

### (D) Organic Solvent

There are no specific limitations to the organic solvent (D) used in the present invention, insofar as the organic solvent can bond the molded article made from the thermoplastic elastomer composition with a molded article of a polar resin (C). Usually, a solvent that can swell or dissolve the molded article of the thermoplastic elastomer composition and/or the molded article of a polar resin (C) is used. As examples of the organic solvent, cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid can be given. At least one solvent selected from these solvents is preferably used.

<Bonding Procedure>

In order to bond the molded article of the thermoplastic elastomer composition with the molded article of a polar resin, at least the bonding parts of one side of these molded articles are caused to come in contact with the organic solvent by a means such as dipping the bonding parts in the organic solvent, spraying the organic solvent onto the bonding parts, or applying the organic solvent to the bonding parts using a brush or waste cloth, whereby those parts are usually swelled or dissolved. After that, those parts are bonded together so that the two molded articles can be solvent-bonded to form a composite molded article. After bonding, the composite molded articles are dried usually at 10-80° C., and preferably 20-60° C., for 1-48 hours, and preferably 2-24 hours.

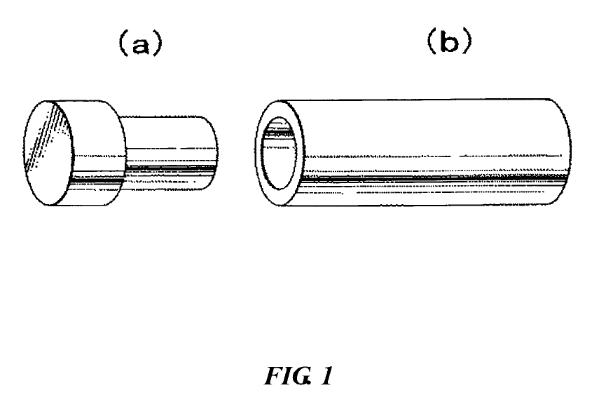

For example, a firmly bonded composite molded article can be obtained by using a molded article of a polar resin as a connector having a tube joining part shown in FIG. 1(a) and a molded article of the thermoplastic elastomer composition as a tube shown in FIG. 1(b), causing the organic solvent to contact with the tube joining part of the connector, i.e. a part of which the outer diameter is approximately the same as the inner diameter of the connector, and/or the inner face of the tip of the tube, and inserting a tube joining part of the connector into the tube to bond them together. When this composite molded article is used as a part for an infusion set for medical treatment, a transparent material with high flexibility is preferable as a tube. The thermoplastic elastomer composition of the present invention containing the syndiotactic 1,2-polybutadiene having a low degree of crystallinity as component (A) is preferably used as the material for the tube.

As another embodiment of the method for bonding the connector and tube, a method of using a tubular joint can be used, wherein the connector and the tube are connected and bonded together by being covered with the tubular joint in a state in which the end face of the connector and the end face of the tube are caused to come in contact with each other or are placed close together. In this case, a firmly bonded composite molded article can be obtained by respectively bonding the connector with the joint and the tube with the joint according to the above-mentioned method. When this composite molded article is used as a part for an infusion set for medical treatment, the thermoplastic elastomer composition containing the syndiotactic 1,2-polybutadiene having a low degree of crystallinity is preferably used as the material for the tube. In order to inhibit deformation due to an internal pressure and to prevent leakage, a material having comparatively high rigidity is preferably used as the joint. The thermoplastic elastomer composition of the present invention containing the syndiotactic 1,2-polybutadiene having a high degree of crystallinity is preferably used as the material for the joint. A polar resin is usually used as the connector. Therefore, the thermoplastic elastomer composition containing the syndiotactic 1,2-polybutadiene having a high degree of crystallinity as the component (A) is preferably used as the material for the joint to be bonded with the connector.

<Composite Molded Article and Infusion Set for Medical Treatment>

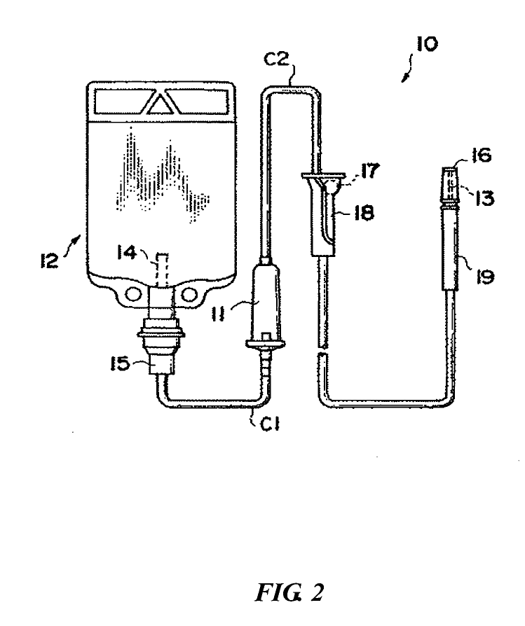

Next, as a specific embodiment of the composite molded article of the present invention, an infusion set for medical treatment will be described referring to FIG. 2.

An infusion set 10 for medical treatment is provided with a connecting member (connector) 15 for connecting an infusion discharge tube 14 in an infusion bag 12, a first tube C1 for connecting the connecting member 15 with a dripping cylinder 11, a second tube C2 for connecting the dripping cylinder 11 and a puncture needle 13, a clamp 18 for adjusting the transfusion rate, and a cap 16 for covering the puncture needle 13. The component indicated by 19 is a connecting member for connecting the second tube C2 and the puncture needle 13.

As the puncture needle 13, a metal needle made from a hollow stainless steel and the like or a synthetic resin needle having a blade edge for puncture at the tip can be used. A roller clamp is used as the clamp 18. This roller clamp is equipped with a roller 17 which is movably installed and narrows the fluid passage of the second tube C2 when moved to the side of the puncture needle 13, thereby controlling the transfusion rate. The dripping cylinder 11 is provided with a filter (not shown) in case foreign matter should be included in the transfusion materials and the like. A conventional puncture needle is used as the puncture needle 13. The connecting member 15, dripping cylinder 11, and connecting member 19 are all connectors having a tube joining part and made from a polar resin such as polycarbonate, polyester, transparent ABS, or vinyl chloride resin.

Therefore, when the tubes C1 and C2 are directly bonded with these connectors, the thermoplastic elastomer composition containing syndiotactic 1,2-polybutadiene having a low degree of crystallinity as the component (A) is preferably used as the material for the tubes C1 and C2. Alternatively, when the tubes C1 and C2 are bonded with each connecting member using a joint, the thermoplastic elastomer composition containing syndiotactic 1,2-polybutadiene having a high degree of crystallinity as the component (A) is preferably used as the material for the joint.

In these cases, a firmly bonded infusion set for medical treatment with a reduced risk of leakage can be obtained by bonding at least one of the ends of the tubes C1 and C2 with connecting parts of the connector having a tube joining part (at least one of the connecting member 15, dripping cylinder 11, and connecting member 19) directly or via a joint using the above-described bonding method.

Japanese Patent Application No. 2005-202557 is hereby incorporated by reference.

Other features of the invention will become apparent in the course of the following description of the exemplary embodiments which are given for illustration of the invention and are not intended to be limiting thereof

### EXAMPLES

The present invention will be described in more detail by examples, which should not be construed as limiting the present invention. In the examples, “parts” and “%” mean “parts by weight” and “wt %”, unless otherwise indicated.

(Raw Materials)

Component (A)

RB830 (syndiotactic 1,2-polybutadiene having a 1,2-bond content of 93% and a degree of crystallinity of 28%, manufactured by JSR Corp.)

Component (B)

TR2827 (SBS with a styrene content of 24%, manufactured by JSR Corp.)

TR2000 (SBS with a styrene content of 40%, manufactured by JSR Corp.)

TR2003 (SBS with a styrene content of 43%, manufactured by JSR Corp.)

TR2250 (SBS with a styrene content of 52%, manufactured by JSR Corp.)

### Examples 1-3 and Comparative Examples 1-4

### Example 1

95% of RB830 and 5% of TR2003 were kneaded at 130-160° C. using a uniaxial extruder (L/D=32) to obtain a thermoplastic elastomer composition.

### Example 2

A thermoplastic elastomer composition was obtained in the same manner as in Example 1 except for using 90% of RB830 and 10% of TR2003.

### Example 3

A thermoplastic elastomer composition was obtained in the same manner as in Example 1 except for using 95% of RB830 and 5% of TR2000.

### Comparative Example 1

A thermoplastic elastomer composition was obtained in the same manner as in Example 1 except that 100% of RB830 alone was used.

### Comparative Example 2

A thermoplastic elastomer composition was obtained in the same manner as in Example 1 except for using 95% of RB830 and 5% of TR2250.

### Comparative Example 3

A thermoplastic elastomer composition was obtained in the same manner as in Example I except for using 95% of RB830 and 5% of TR2827.

### Comparative Example 4

A thermoplastic elastomer composition was obtained in the same manner as in Example 1 except for using 80% of RB830 and 20% of TR2003.

(Preparation of Test Specimen)

Molding of Thermoplastic Elastomer Composition (Plates 1 and 2)

The composition obtained in Examples and Comparative Examples were molded using an injection molding machine at 130-160° C. to obtain a plate 1 (for bonding) with a length of 60 mm, a width of 30 mm, and a thickness of 3 mm.

The compositions obtained in Examples and Comparative Examples were molded using a press molding machine at 150° C. to obtain a plate 2 (for haze value measurement) with a length of 100 mm, a width of 70 mm, and a thickness of 1 mm.

Molding of Polar Resin (Plate 3)

A polycarbonate resin (“Panlight K-1285J” manufactured by Teijin Chemicals, Ltd.) was molded using an injection molding machine at 250-300° C. to obtain a plate 3 with a length of 60 mm, a width of 30 mm, and a thickness of 3 mm.

(Bonding of Plate 1 and Plate 3)

1 cc of a bonding solvent (cyclohexane) was dripped onto the upper surface of plate 1 in the area 5 mm from the right end in the lengthwise direction. Then, the area 10 mm from the right end in the lengthwise direction, including the area onto which cyclohexane was dripped, of the plate 1, was overlaid with the area 10 mm from the left end in the lengthwise direction of plate 3 (the bonding area was 10 mm (length direction)×30 mm (width direction)). With the bonding faces being clipped together using a clip, the overlaid plates were dried at 60° C. for 24 hours and allowed to stand at room temperature for two hours to obtain a bonding test specimen.

(Evaluation)

Tensile Shear Bonding Strength

The tensile shear bonding strength of the bonding test specimen was measured at a drawing rate of 10 mm/min using a universal tensile tester (“AG2000” manufactured by Shimadzu Corp.). The results are shown in Table 1.

Haze Value

Haze value was measured using the plate 2 according to a method of ASTM D-1003. Haze value is a measure for indicating transparency. The smaller the haze value, the better the transparency.

TABLE 1

| | Example | | | Comparative Example | | | |
|---|---|---|---|---|---|---|---|
| | 1 | 2 | 3 | 1 | 2 | 3 | 4 |
| RB830 | 95 | 90 | 95 | 100 | 95 | 95 | 80 |
| TR2003 (styrene content: 43 wt %) | 5 | 10 | | | | | 20 |
| TR2000 (styrene content: 40 wt %) | | | 5 | | | | |
| TR2250 (styrene content: 52 wt %) | | | | | 5 | | |
| TR2827 (styrene content: 24 wt %) | | | | | | 5 | |
| Tensile shear bonding strength | 17 | 18 | 16 | 7 | 11 | 8 | 19 |
| (kg/cm²) | | | | | | | |
| Haze value (%) | 71 | 78 | 72 | 64 | 76 | 70 | 96 |

Test specimens of Examples 1-3 showed greatly improved tensile shear bonding strength as compared with that of the test specimen of Comparative Example 1 made from 100% syndiotactic 1,2-polybutadiene. Although the test specimens of Examples 1-3 had haze values slightly larger than the test specimen of Comparative Example 1, these test specimens of Examples 1-3 were sufficiently transparent in practice. Improvement of the tensile shear bonding strength was modest in the test specimen of Comparative Example 2 to which SBS with a styrene content of 52% was added and the test specimen of Comparative Example 3 to which SBS with a styrene content of 24% was added. The test specimen of Comparative Example 4 to which 20% of SBS was added showed an increased haze value of 96% and was almost opaque.

### INDUSTRIAL APPLICABILITY

The thermoplastic elastomer composition of the present invention can be used for various applications, particularly as a composition for medical use, due to the excellent bonding strength with a polar resin. The method for bonding of the present invention can firmly bond molded articles of the thermoplastic elastomer composition with molded articles of a polar resin. The composites molded articles produced by using this method can be used for various applications including components for medical treatment such as an infusion set for medical treatment.

Obviously, numerous modifications and variations of the present invention are possible in light of the above teachings. It is therefore to be understood that within the scope of the appended claims, the invention may be practiced otherwise than as specifically described herein.

What is claimed is:

1. A thermoplastic elastomer composition comprising:
(A) 85-98 wt % of syndiotactic 1,2-polybutadiene having a 1,2-bond content of 70% or more and a degree of crystallinity of 5-50% and
(B) 2-15 wt % of a styrene-butadiene-styrene block copolymer and/or styrene-isoprene-styrene block copolymer with a styrene content of 35-45 wt %, provided that (A)+(B) is 100 wt %.

2. The thermoplastic elastomer composition according to claim 1, wherein the thermoplastic elastomer composition is a composition for medical use.

3. A method for bonding molded articles, comprising bonding a molded article of the thermoplastic elastomer composition according to claim 1 or 2 with (C) a polar resin molded article using (D) an organic solvent.

4. The method for bonding molded articles according to claim 3, wherein the polar resin (C) is at least one resin selected from the group consisting of a polycarbonate resin, ABS resin, polyurethane resin, polyamide resin, poly(ethylene terephthalate) resin, poly(alkyl acrylate) resin, poly(alkyl methacrylate) resin, polyacetal resin, poly(vinyl chloride) resin, and poly(vinylidene chloride) resin.

5. The method for bonding molded articles according to claim 3, wherein the organic solvent (D) is at least one solvent selected from the group consisting of cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid.

6. The method for bonding molded articles according to claim 4, wherein the organic solvent (D) is at least one solvent selected from the group consisting of cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid.

7. A composite molded article comprising a molded article of the thermoplastic elastomer composition according to claim 1 or 2 bonded with a molded article of a polar resin (C).

8. The composite molded article according to claim 7, wherein the polar resin (C) is at least one resin selected from the group consisting of a polycarbonate resin, ABS resin, polyurethane resin, polyamide resin, poly(ethylene terephthalate) resin, poly(alkyl acrylate) resin, poly(alkyl methacrylate) resin, polyacetal resin, poly(vinyl chloride) resin, and poly(vinylidene chloride) resin.

9. The composite molded article according to claim 7, wherein the molded articles are bonded using a solvent adhesive in which at least one organic solvent selected from the group consisting of cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid is used.

10. The composite molded article according to claim 8, wherein the molded articles are bonded using a solvent adhesive in which at least one organic solvent selected from the group consisting of cyclohexane, cyclohexanone, tetrahydrofuran, methyl ethyl ketone, acetone, toluene, diethyl ketone, ethyl acetate, dichloroethane, dichloromethane, ethanol, methanol, carbon disulfide, and acetic acid is used.

11. An infusion set for medical treatment equipped with the composite molded article according to claim 7.

12. An infusion set for medical treatment equipped with the composite molded article according to claim 8.

13. An infusion set for medical treatment equipped with the composite molded article according to claim 9.

14. An infusion set for medical treatment equipped with the composite molded article according to claim 10.
